(19) United States
(12) Patent Application Publication
(10) Pub. No.: US 2014/0372269 A1
(43) Pub. Date: Dec. 18, 2014

(54) METHODS AND SYSTEMS FOR PROVIDING A GRAPHICAL USER INTERFACE THAT ALLOWS LENDEES TO SELECT PAYMENT TERMS

(71) Applicant: OrthoFi, Inc., Denver, CO (US)

(72) Inventors: David Lawrence Ternan, Denver, CO (US); Michael Elmer Westphal, Denver, CO (US)

(73) Assignee: OrthoFi, Inc., Denver, CO (US)

(21) Appl. No.: 14/252,916

(22) Filed: Apr. 15, 2014

Related U.S. Application Data
(60) Provisional application No. 61/835,989, filed on Jun. 17, 2013.

(51) Int. Cl. G06Q 40/00

(52) U.S. Cl. CPC G06Q 40/00
USPC 705/35

(57) ABSTRACT

Systems and methods selecting payment terms. One system includes a computing device configured to receive cost information and determine available payment options. The computing device is also configured to generate a graphical user interface based on the payment options. The graphical user interface includes a slider graphically illustrating a range of values for a payment term and a selector movable within the slider for selecting a value within the range, wherein the range of values includes a discount range. The computing device is configured to receive input from a lendee indicating a desired value from the range of values for the payment term based on a position of the selector along the range, determine if the desired value is within the discount range, and calculate a payment plan based on the desired value, wherein the payment plan includes a discount when the desired value is within the discount range.

### RELATED APPLICATION

The present application claims the benefit of prior-filed, co-pending U.S. Provisional Patent Application No. 61/835,989, filed on Jun. 17, 2013, the entire content of which is hereby incorporated by reference.

### BACKGROUND

Patients often require financing to pay for medical expenses, such as dental expenses. Typically, the service provider (or a third-party financing party) offers the patient a financing option that includes payment terms. The financing option provided to the patient may not be the best one for the patient. For example, the patient may be willing to pay larger monthly payments or a larger down payment to decrease the overall amount of the loan. Alternatively, the patient may be more comfortable paying a smaller monthly payment over a longer period of time. Accordingly, in some situations, the patient may reject the offer. In other circumstances, the patient may attempt to modify the payment terms, which increases the overall time and resources needed to complete the financing transaction. In still other circumstances, the patient may accept the offer but may be dissatisfied with the transaction, which impacts the patient's future business with the service provider.

### SUMMARY

Embodiments of the invention provide methods and systems for generating a user interface that allows a payer or lendee (e.g., a patient) to provide input for payment terms. In particular, the methods and systems generate a GUI that allows the lendee to vary one or more of the payment terms. The lendee can change the terms within bounds set (e.g., automatically) based on parameters associated with the lendee (e.g., a credit score) and the lender. Accordingly, the lendee is put in control of the payment terms, which makes the lendee more fully informed of the available options and leads to lendee and lender satisfaction with the payment situation.

One embodiment of the invention provides a system for selecting payment terms. The system includes a computing device configured to receive cost information and determine available payment options. The computing device is also configured to generate a graphical user interface based on the payment options. The graphical user interface includes a slider graphically illustrating a range of values for a payment term and a selector movable within the slider for selecting a value within the range, wherein the range of values includes a discount range. The computing device is configured to receive input from a lendee indicating a desired value from the range of values for the payment term based on a position of the selector along the range, determine if the desired value is within the discount range, and calculate a payment plan based on the desired value, wherein the payment plan includes a discount when the desired value is within the discount range.

Another embodiment of the invention provides a method for allowing a lendee to select payment terms. The method includes receiving cost information and determining available payment options based on the cost information. The method also includes generating, by a computing device, a graphical user interface based on the available payment option. The graphical user interface includes a slider that graphically illustrates a range of values for a payment term. The range of values includes a discount range. The graphical user interface also includes a selector that is movable within the slider for selecting a value within the range of values. The method further includes receiving input, by the computing device, from the lendee indicating a desired value from the range of values for the payment term based on a position of the selector along the range of values, determining, by the computing device, if the desired value is within the discount range, and calculating, by the computing device, a payment plan based on the desired value. The payment plan includes a discount when the desired value is within the discount range.

Other aspects of the invention will become apparent by consideration of the following detailed description and figures.

### BRIEF DESCRIPTION OF THE FIGURES

FIG. 1 is a flow chart illustrating a method of selecting payment terms for a dental procedure.

FIG. 2 schematically illustrates a system configured to perform at least a portion of the method of FIG. 1.

FIGS. 3a-e are screen shots illustrating a graphical user interface provided to a lendee as part of the method of FIG. 1.

FIG. 4 is a flow chart illustrating a method of selecting payment terms for a vehicle.

FIG. 5 is a screen shot of a GUI provided to a lendee as part of the method of FIG. 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium). Accordingly, it should be noted that a plurality of hardware and software based devices, as well as a plurality of different structural components may be utilized to implement the invention.

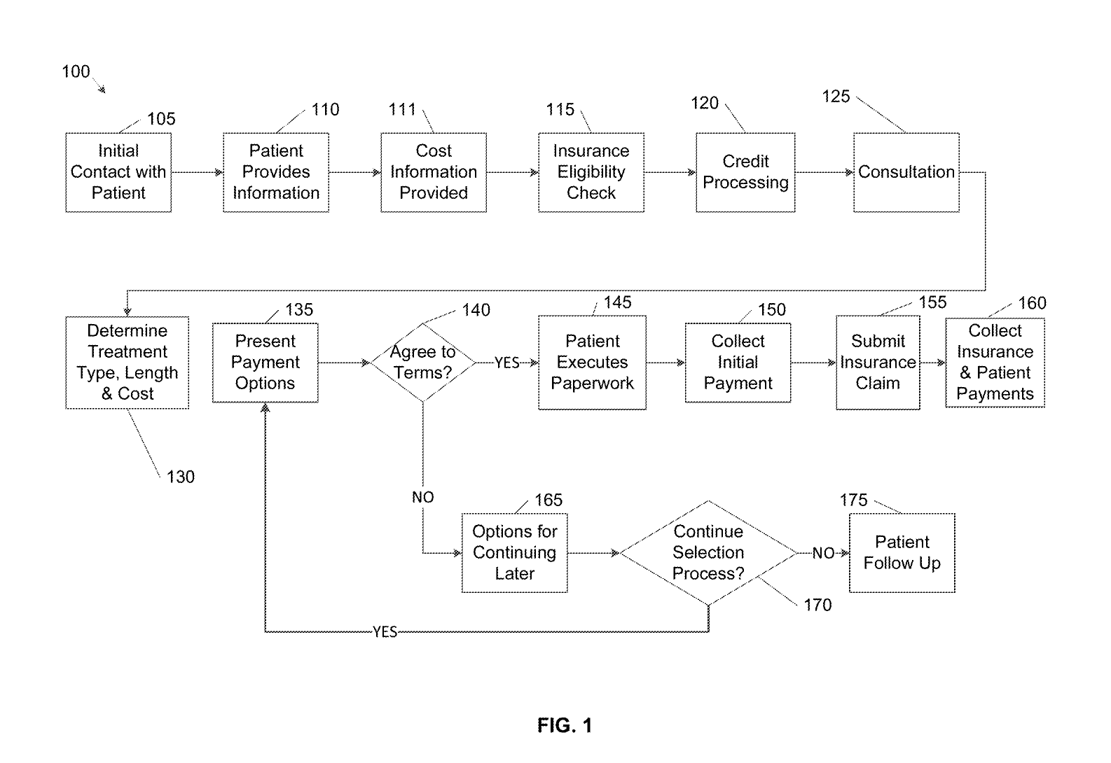

FIG. 1 is a flow chart illustrating a method 100 of selecting payment terms. It should be understood that although the method of FIG. 1 is described in terms of a dental procedure, the method can generally be used with other types of transactions and is not limited to use within the dental or medical industry. As illustrated in FIG. 1, initial contact is established with a patient (e.g., using a telephone call) (at block 105). During this contact, basic personal information can be collected from the patient, such as name, guardian information, address, phone number, email address, time and date of patient examination or consultation, type of patient (e.g., existing, recall, new, etc.), and any patient concerns or notes. During the initial contact, the patient can also be informed of payment options (e.g., financing services) available for the patient's dental services.

If, during the initial contact, the patient is interested in payment options, the patient completes one or more forms to provide lendee information (at block 110). The forms can be completed on paper or electronically. For example, in some embodiments, the patient can be emailed a link for accessing one or more forms electrically. Therefore, the patient can complete the forms online before the patient visits the dental service provider's office. Alternatively, the patient can use a computer (e.g., laptop, desktop, or tablet computer) located at the service provider's office to complete the forms before the patient's procedure at the office. The lendee information requested on the forms can include personal information (e.g., date of birth), credit information (e.g., length of time at current residence, permission to run credit check), insurance information (e.g., policies, deductibles, etc.), and survey questions. The survey questions can relate to the payment preferences or payment history for the patient (e.g., what terms are important to the patient relating to financing). In some embodiments, the forms also prompt the patient for medical history information.

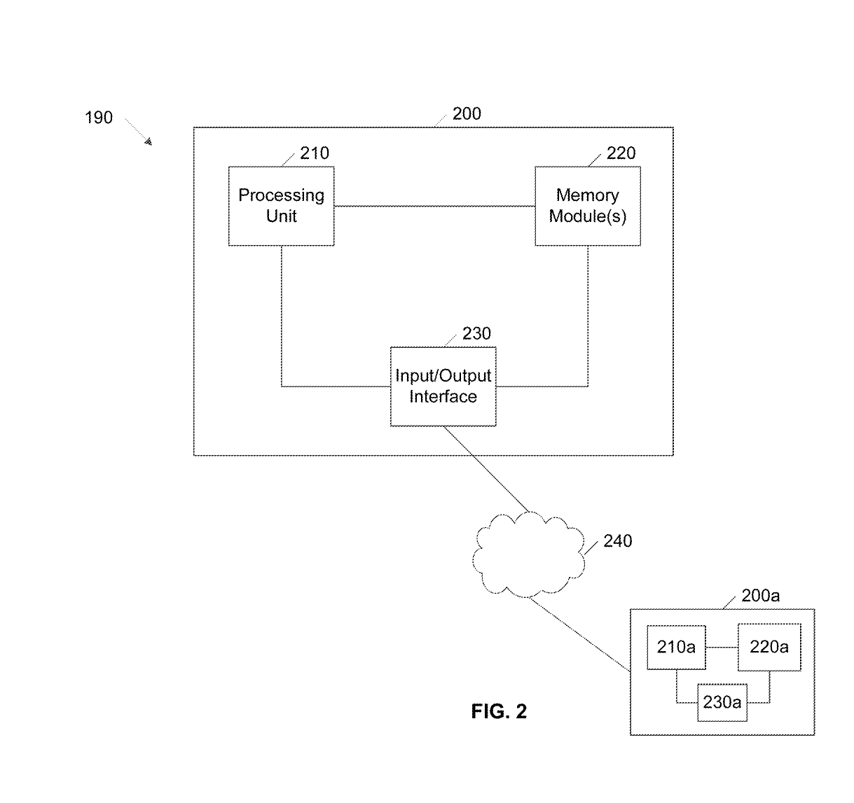

All or a part of the collected information (e.g., personal information and lendee information, including answers to the survey questions) can be input into a computer system, such as the system 190 illustrated in FIG. 2. Additionally, cost information (such as the cost of the procedure, additional fees related to the procedure, or any other cost-related information related to the procedure) can be input into the computer system 190 (at block 111). The system 190 includes at least one computing device 200. The computing device 200 includes a processing unit 210 (e.g., a microprocessor), one or more non-transitory memory modules 220 (e.g., read-only memory and/or random access memory), and one or more input/output interfaces 230. The processing unit 210 retrieves instructions (and data) from the memory module 220 and executes the instructions to perform the functionality described herein.

The input/output interface 230 communicates with devices, systems, and networks external to the computing device 200, such as peripheral devices (e.g., a display device, a printer, etc.) or additional computing devices. For example, as illustrated in FIG. 2, in some embodiments, the computing device 200 is a server that is accessible by one or more other computing devices 200a (e.g., laptop computers, desktop computers, tablet computers, smart phones, smart televisions, and other devices capable of connecting to a server over at least one network). In this configuration, the computing device 200 can be accessible over one or more networks 240, such as the Internet, a local area network (“LAN”), or a wide area network (“WAN”). For example, a patient can use a personal computer 200a (e.g., a tablet computer, laptop computer, smart phone, etc.) to access a webpage hosted by the computing device 200. The patient can use the website to enter personal information and/or lendee information as described above. The patient can also use the website to review and accept payment terms as described below. It should be understood that the computing device 200 can include additional components than those illustrated in FIG. 2. Furthermore, in some embodiments, the functionality of the computing device 200 described herein can be combined and distributed among multiple computing devices 200.

Returning to FIG. 1, after receiving the requested information from the patient, an insurance eligibility check is performed (at block 115). The insurance eligibility check is conducted to determine whether the patient has insurance and whether the particular procedure being considered by the patient is covered by the patient's insurance. The eligibility check can be an automated process performed by the computing device 200. However, in some cases, the insurance eligibility check can include one or more manual processes (e.g., if the insurance information provided by the patient is incomplete or otherwise not readily available for automatic processing). If the check is performed automatically using the computing device 200, the check can typically be performed faster than if the check was performed manually. For example, if the insurance eligibility check cannot be automated, the eligibility check can be queued for a customer service representative to perform a manual insurance eligibility check. If the patient is in the office at the time of the insurance eligibility check, however, the eligibility check request can be placed at the top of the queue for a quicker turn-around time. It should be understood that multiple insurance eligibility checks can be performed, such as when the patient has more than one insurance plan. Also, it should be understood that the computing device 200 can communicate with one or more external devices or systems to perform the check (e.g., an insurance company system).

In addition to the insurance eligibility check, a credit check can be performed (at block 120). The credit check can include retrieving credit data (e.g., from a credit bureau) associated with the patient. The output of the check can be a credit score for the patient. It should be understood that the credit score can be different than a credit score provided by a credit bureau. For example, in some embodiments, the credit score determined as part of the credit check has a value between 1 and 100. It should also be understood that the credit score can be based on information other than the patient's credit information. For example, the credit score can be based on other information provided by the patient (e.g., the patient's answers to the survey questions) and/or available from other sources (e.g., payment history between the patient and various entities).

As with the insurance eligibility check, the credit check can be performed automatically by the computing device 200 and/or can include one or more manual processes. For example, if the credit information provided by the patient is incomplete or incorrect, the computing device 200 can flag the credit check request as needing manual completion (such as by a customer service representative). In some embodiments, if the patient is in the office at the time of the credit check, the flagged credit check request can be placed at the top of the queue for a quicker turn-around time.

As illustrated in FIG. 1, after the initial checks have been performed for the patient, the patient undergoes his or her consultation with the service provider (at block 125). During the consultation, the dental service provider prescribes or recommends a procedure for the patient and provides procedure information that defines the recommended procedure (at block 130). The procedure information can include a total payment amount, a procedure length, a procedure type, procedure options, insurance code(s), diagnoses, procedure coordinator identifier(s), etc.

The procedure information is input into the computing device 200. However, if it is determined that the patient is not ready or not eligible for the procedure (such as if the patient, the insurance eligibility check, and/or the credit check information disqualify the patient), the patient is placed on “recall”. In this situation, the method 100 can be suspended until the patient is ready or becomes eligible for the procedure. If the method 100 is suspended for a particular patient, the procedure information may not be input into the computing device 200.

Using the procedure information, the personal information, the lendee information, the cost information, and the results of the insurance eligibility check and credit check, the computing device 200 determines available payment options and presents the options to the patient (at block 135). The payment options can include one or more payment terms, such as an initial annual percentage rate (“APR”), an initial APR length, an extended APR, an extended APR length, and a minimum down payment. As described below in more detail, the patient can modify one, multiple, or all of the payment terms to design a customized payment plan.

For example, in some embodiments, the computing device 200 generates a graphical user interface (“GUI”) that presents the payment options to the patient. The GUI allows the patient to select values for particular payment terms for paying for the procedure. The selectable payment terms can include a down payment amount and/or a periodic (e.g., monthly) payment amount. As described in more detail below, the selectable payment terms presented in the GUI can be limited to those acceptable to the lender. Accordingly, the patient can use the GUI to select payment terms that best fit the patient's financial situation while still being acceptable to the lender. In some embodiments, the GUI is initially presented to the patient as part of the patient's consultation or office visit (e.g., at a computer located at the dental office). In other embodiments, the patient can access the GUI remotely (e.g., through a connection with the computing device 200 over the Internet or another network using a patient's personal computer 200a).

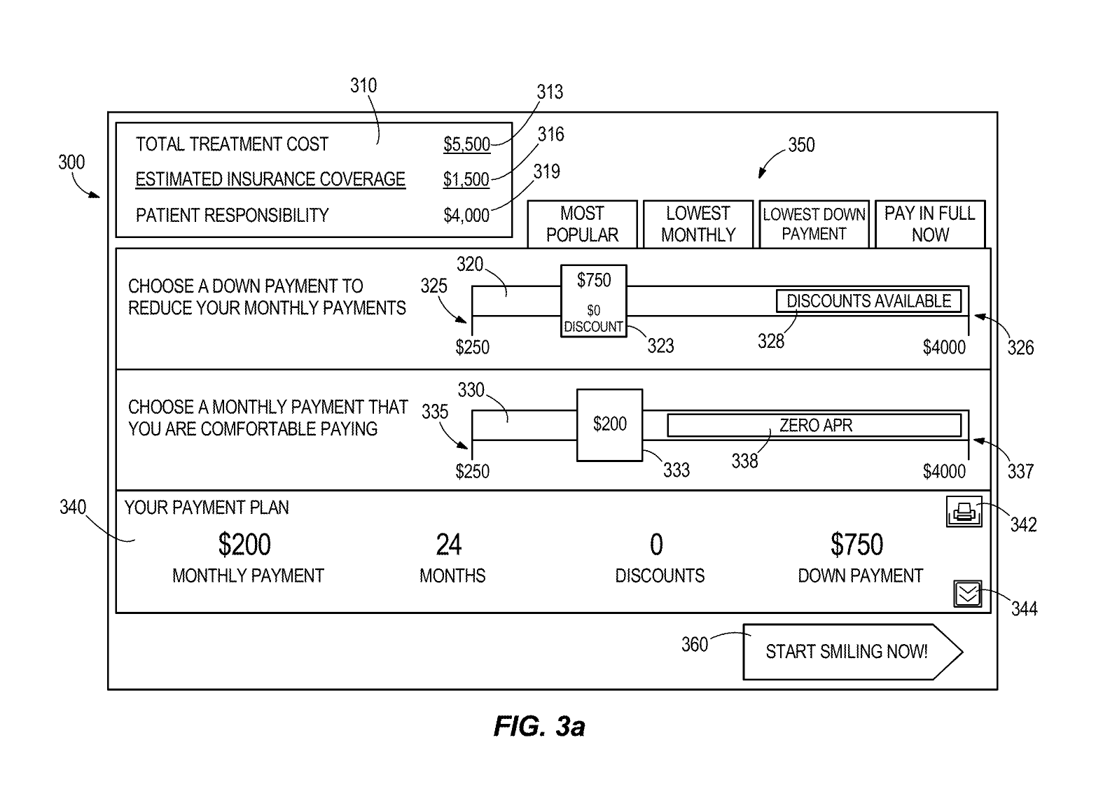

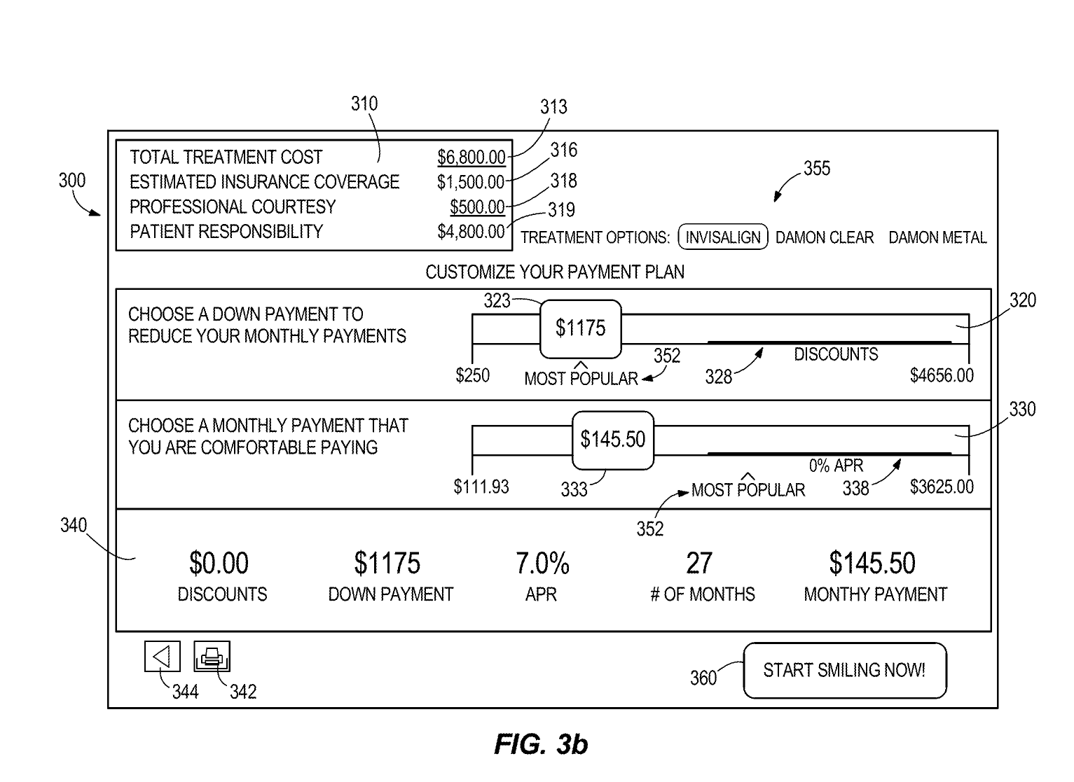

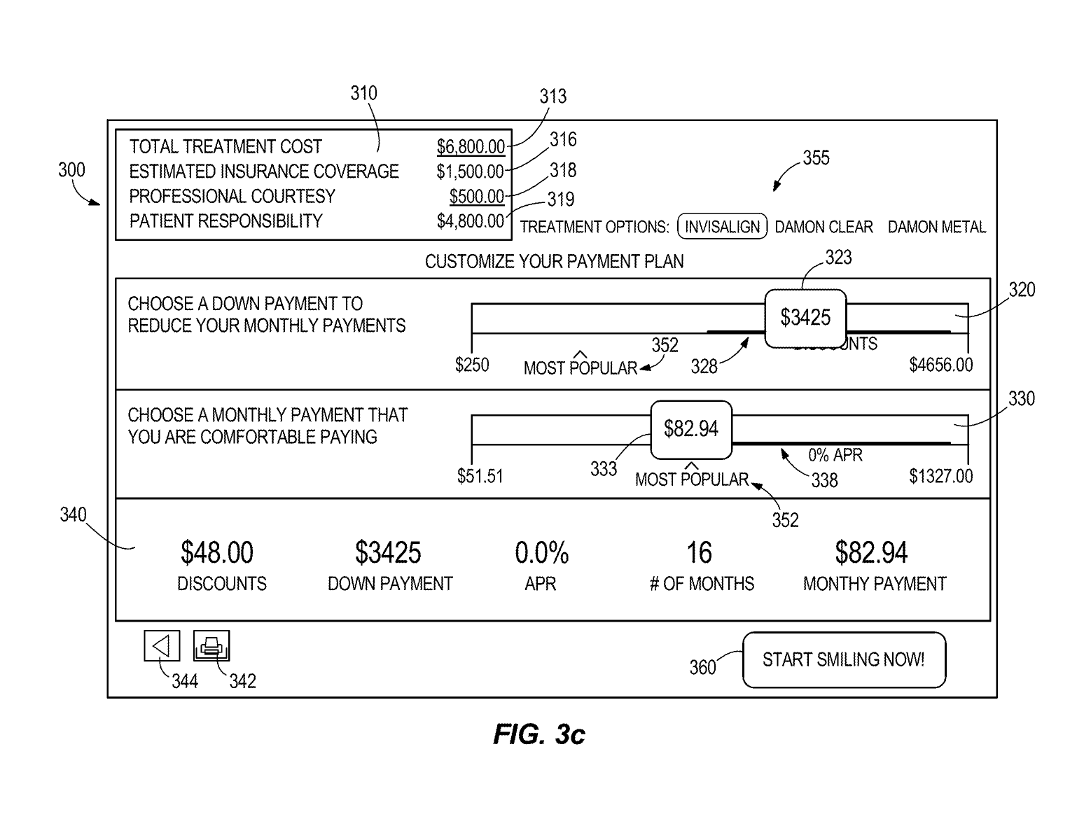

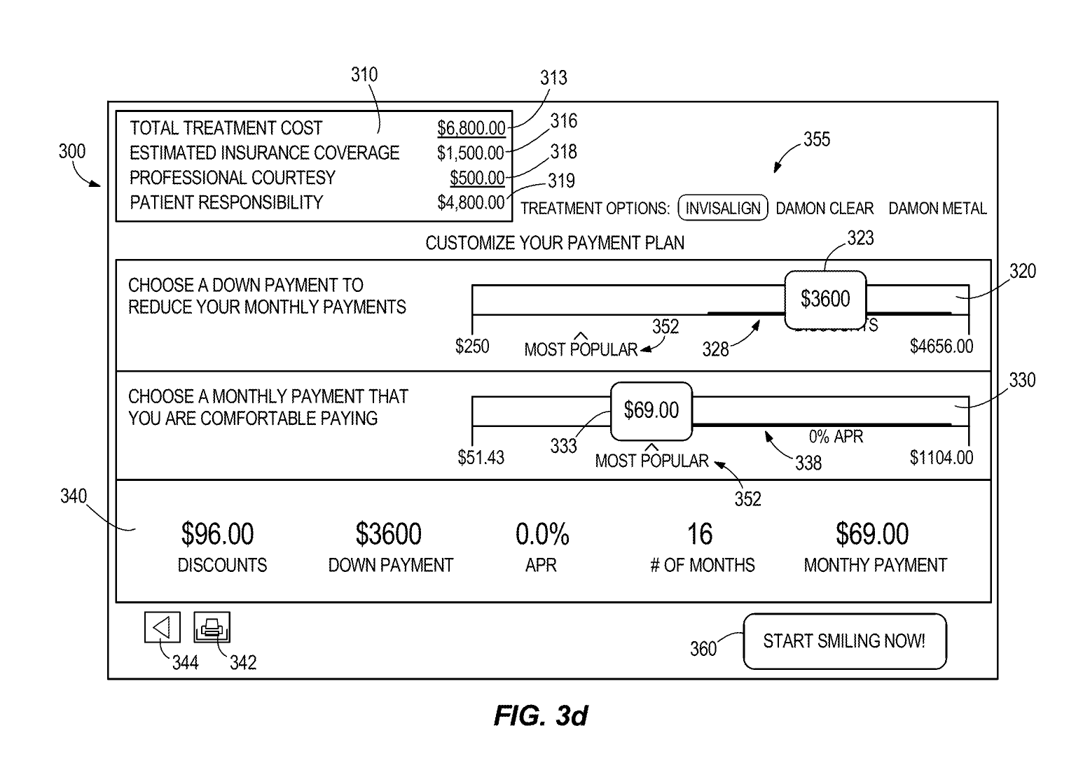

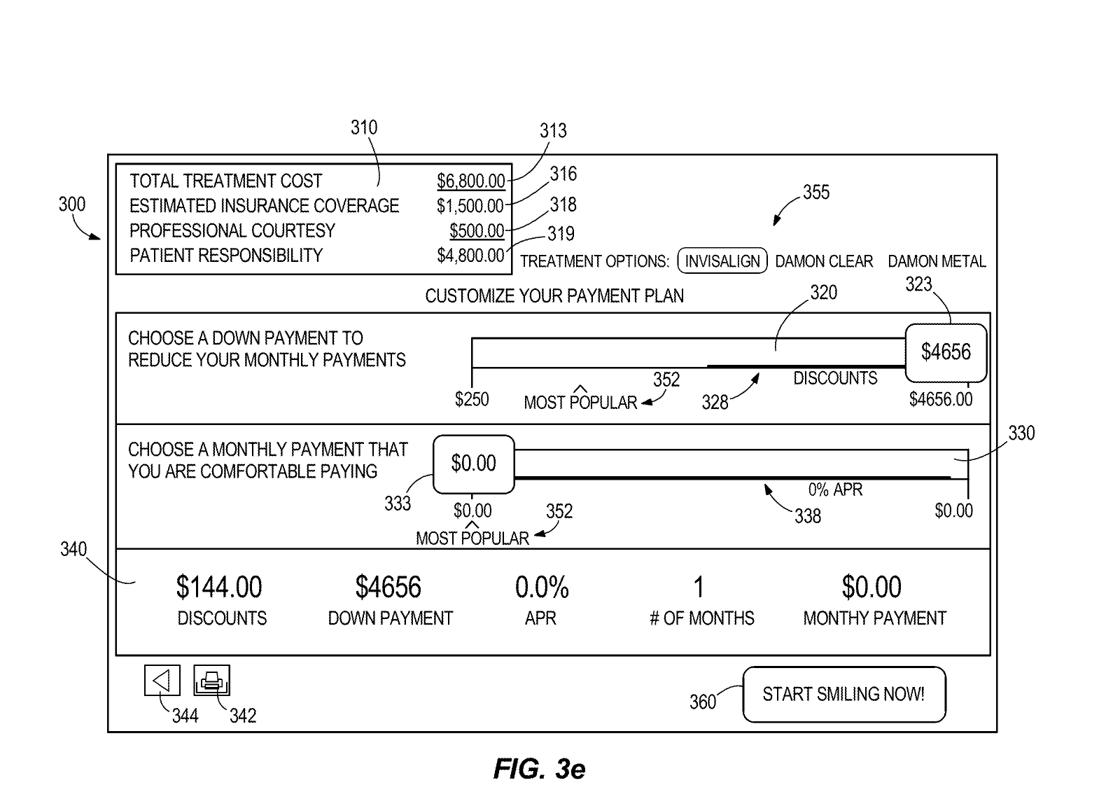

For example, FIGS. 3a-e are screen shots of a GUI 300 provided to the patient according to one embodiment of the invention. As illustrated in FIG. 3a, the GUI 300 includes a cost summary section 310 that informs the patient of the total procedure cost 313, estimated insurance coverage 316, available discounts 318 (see FIG. 3b), and a patient responsibility amount 319 (i.e., the difference between the total procedure cost 313 and the sum of the estimated insurance coverage 316 and any discounts 318). In some embodiments, if the patient hovers over or selects the total procedure cost 313, the estimated insurance coverage 316, the discount 318, or the patient responsibility amount 319, the GUI 300 generates a pop-up. The pop-up can display information regarding what is included in each of the amounts 313, 316, 318, and 319 and/or additional information pertinent to a particular cost.

The GUI 300 also includes a first slider 320 with a first slide selector 323. The first slide selector 323 is movable along the first slider 320. The first slider 320 is associated with a payment term. For example, as illustrated in FIGS. 3a-e, the first slider 320 can represent a range of down payment values. As illustrated in FIG. 3a, a lower limit 325 of the slider 320 (i.e., the leftmost end of the slider 320) represents a minimum down payment (e.g., $250). This minimum amount can be set based on parameters associated with the lender or the patient (e.g., the patient's credit score). Similarly, an upper limit 326 of the range (i.e., the rightmost end of the slider 320) is set to the total procedure cost 313 (e.g., $4,000).

As illustrated in FIGS. 3a-e, in some embodiments, the GUI 300 also includes a second slider 330 with a second slide selector 333. Similar to the first selector 323, the second selector 330 is movable along the second slider 330. The second slider 320 is also associated with a payment term. For example, as illustrated in FIGS. 3a-e, the second slider 330 can represent a periodic (e.g., monthly) payment amount. Therefore, the lower limit 335 of the slider 330 can represent a minimum monthly payment amount (e.g., $125), and the upper limit 337 of the slider 300 can represent a maximum monthly payment amount (e.g., a one-time payment of the total procedure cost 313). The minimum monthly payment amount can be set based on parameters associated with the lender and/or the patient (e.g., the patient's credit score).

It should be understood that the GUI 300 can include only one slider or may include more than two sliders, wherein each slider is associated with a different payment term (e.g., a payment period term, an interest rate, a number-of-months slider, a discount amount, etc.). Also, if the GUI 300 includes more than one slider, each slider can operate independently of the other sliders or can automatically change based on one or more other sliders. For example, if the patient selects a higher down payment amount, the position of the second slide selector 333 can be automatically updated to reflect a lower monthly payment for the same number of months (see, FIGS. 3c-d). In addition or alternatively, the limits of each slider can be automatically adjusted based on the position of selectors on other sliders. Furthermore, in some embodiments, the GUI 300 allows a user to manually enter amounts for one or more of the payment terms rather than using a slider.

The GUI 300 also includes a summary section 340. The summary section 340 lists the payment terms, which can include a periodic (e.g., monthly) payment amount, a term of the payment period (e.g., a number of months), a down payment amount, an interest rate, and/or a discount amount. The summary section 342 can include a print button 342 that a patient can select to print the summary section 340, other portions of GUI 300, and/or other information not presented on the GUI 300. Similarly, the summary section 340 can include an expand button 344. A patient can select the expand button 344 to view more information regarding the payment terms (e.g., additional financial terms or conditions). In some embodiments, selecting the expand button 344 also allows a patient to review information used to create the GUI 300 (e.g., personal information, credit information, etc.) and update the information as needed (e.g., request a new credit check, add additional insurance information, etc.).

One or more of the payment terms can be fixed. For example, in some embodiments, the interest rate and/or the number of months are fixed. However, one or more of these terms are variable and change based on the position of each selector 323, 333. In particular, as the patient moves the first slide selector 323 along the first slider 320, the payment terms are automatically updated in the summary section 340. In some embodiments, as illustrated in FIGS. 3a-e, each selector 323 and 333) also displays the currently-selected payment term (i.e., specified by the position of the selector on the associated slider). Accordingly, a patient can manipulate the first slide selector 323 to view how different down payment amounts change the patient's payment terms and can manipulate the second slider selector 333 to view how different monthly payment amounts change the patient's payment terms. It should be noted that when more than one slider is included in the GUI 300, the updated values in the summary section 340 reflect the updated values as influenced by the current position of each slider.

In some embodiments, a portion of each slider 320, 330 can be associated with a discount range. For example, as illustrated in FIGS. 3a-e, a portion of the first slider 320 is associated with a discount range 328. If a patient selects a down payment amount within the discount range 328, the patient receives a discount on the procedure. For example, as illustrated in FIGS. 3c-e, if the first slide selector 323 is positioned within the discount range 328, a discount (e.g., $144) is applied to the patient responsibility amount 319 (e.g., lowering the amount from $4,800 to $4,656.00). Accordingly, the upper limit 326 of the first slider 320 can be changed to reflect this available discount. The summary section 340 is also updated to reflect the discount amount. In some embodiments, as illustrated in FIG. 3a, the first slide selector 323 also displays the discount amount applied based on the current position of the first slider selector 323.

Similarly, as illustrated in FIGS. 3a-e, a portion of the second slider 330 is associated with a discount range 338. If a patient selects a monthly payment amount within the discount range 338, the patient receives a discount on the procedure. For example, as illustrated in FIGS. 3c-e, if the second slide selector 333 is positioned within the discount range 338, a discount (e.g., a 0% interest rate) is applied (e.g., as compared to a 7.0% shown in FIG. 3b). The summary section 340 is updated to reflect the discount.

The discount applied can be a fixed discount along the length of a discount range, or the discount amount can vary. For example, as the patient increases the down payment amount within the discount range 328, the discount amount can also increase. Also, in other embodiments, the slider 320 can include multiple discount ranges associated with different types of discounts (e.g., lower interest rates, one or more initial months free, etc.). When the user moves the selector 323 into one of the discount ranges, the associated discount is triggered and applied to the payment terms. Also, in some embodiments, the size of the discount range can vary based on the position of one or more selectors 323, 333. For example, as illustrated in FIGS. 3c-e, as the first slide selector 323 is moved toward the pay-in-full amount (i.e., the maximum down payment amount), the length of the discount range 338 for the second slider 330 increases toward a minimum monthly payment amount. Therefore, as a patient increases the amount of the down payment amount, more monthly payment options are available at the 0% APR discount.

In some embodiments, the GUI 300 also provides the patient with one or more default or preset options for payment terms. For example, as illustrated in FIG. 3a, the GUI 300 can include one or more default tabs 350. When a patient selects one of the tabs 350, the GUI 300 displays preset positions of the first and second slide selectors 323 and 333 that correspond to predetermined payment terms. For example, the tabs 350 can include a most-popular terms default (e.g., based on historical data of payment terms accepted by patients), a lowest-monthly-payment default, a lowest-down-payment default, and a pay-in-full default. In some embodiments, a patient can change the positions of the selectors 323 associated with a particular tab 350. For example, a patient can select one of the tabs 350 and can use the preset positions of the selectors 323 as a starting point for designing customized payment terms. In some embodiments, rather than providing the tabs 350, a selector can include a designation of a default or preset value. For example, as illustrated in FIGS. 3a-e, each slider 320, 330 can include a marker 352 that designates the most-popular value (e.g., a most popular down payment amount and a most popular monthly payment amount). The markers 352 can automatically update based on the position of the sliders. For example, the markers 352 can suggest a most popular down payment amount for a selected monthly payment and vice versa. Accordingly, certain combinations of the selected down payment and monthly payment amounts can cause one or both of the markers 352 to change.

As illustrated in FIGS. 3b-e, the GUI 300 can also include one or more procedure option tabs 355. For example, if a procedure selected by the patient has multiple options (e.g., material options, such as plastic or metal, cosmetic options, brand options, etc.), the GUI 300 can allow the patient to select different procedure options to see whether each option is associated with different payment terms and/or selections (e.g., different amounts, different types of selectors, different discounts, etc.). For example, as illustrated in FIGS. 3b-e, a patient can select the option tabs 355 to see the available payment terms for an Invisalign procedure, a Damon Clear procedure, and a Damon Metal procedure.

Returning to FIG. 2, after the patient sets the payment terms as desired, the patient agrees to the selected terms (at block 140). For example, the patient can select an accept button 360 (e.g., a “Start Smiling Now” button) on the GUI 300 to submit the terms to the computing device 200. The computing device 200 generates documentation based on the accepted payment terms. The computing device 200 can also generate forms required for the payment terms. The patient executes (e.g., initials and/or signs manually or electronically) the necessary paperwork (at block 145). In some embodiments, the computing device 200 generates executed versions of all of the documents (e.g., PDF versions) and provides the patient with access to the executed versions (e.g., by allowing the patient to print a copy of the documents, emailing the patient a copy of the documents, and/or providing the patient with a link for accessing the documents).

After all the necessary paperwork is complete, the initial payment (e.g., the down payment and/or the first month payment) can be collected from the payment (at block 150). The payment can be collected using an automated clearing house (“ACH”) transaction (e.g., based on a name, routing number, and account number provided by the patient), a credit or debit transaction (e.g., based on a name, card number, and security code provided by the patient), a flexible spending account transaction, a check transaction, or a cash transaction. In some embodiments, the patient can use the computing device 200 to complete the payment. The patient can also set up automated billing for future payments through the computing device 200.

If applicable, an insurance claim can also be submitted to the patient's insurance provider(s) (at block 155). In some embodiments, the claim is submitted electronically. As noted above, because insurance information was collected from the patient earlier in the process, in some embodiments, no additional information is required from the patient to submit the claim.

After submitting the claim, the insurance payment(s) are collected and applied to the patient's account (at block 160). Similarly, patient payments are collected and applied to the patient's account (also at block 160).

Alternatively, if the patient does not agree to any payment terms (at block 140), the GUI 300 can provide the patient with options for continuing the payment term selection process at a later date or from a different location (at block 165). For example, the patient can print out one or more options for the payment terms (e.g., using the print button 342). Alternatively or in addition, the computing device 200 can provide the patient (e.g., through an email) a link to access the GUI 300 at a later date (and from a different location). The patient can use this access to continue the selection process (at block 170). The email containing the access link to the GUI 300 can also include other information, such as a description of the procedure and notes from the patient's consultation.

Additionally, follow-up notices (e.g., emails, phone calls, mailings, etc.) can be sent to the patient if the patient has not yet selected payment terms (at block 175). The follow-up notices can also inform the patients of upcoming appointments and see if the patient is interested in another procedure or appointment. Also, if a patient payment is coming due or is overdue for under previously-selected payment terms, the follow-up notice can inform the patient of the deadline. If a patient responds to a particular follow-up, notes can be generated (e.g., by customer service representatives—including a patient's reasons for canceling the payment selection process, etc.) that can be used for subsequent patient interactions.

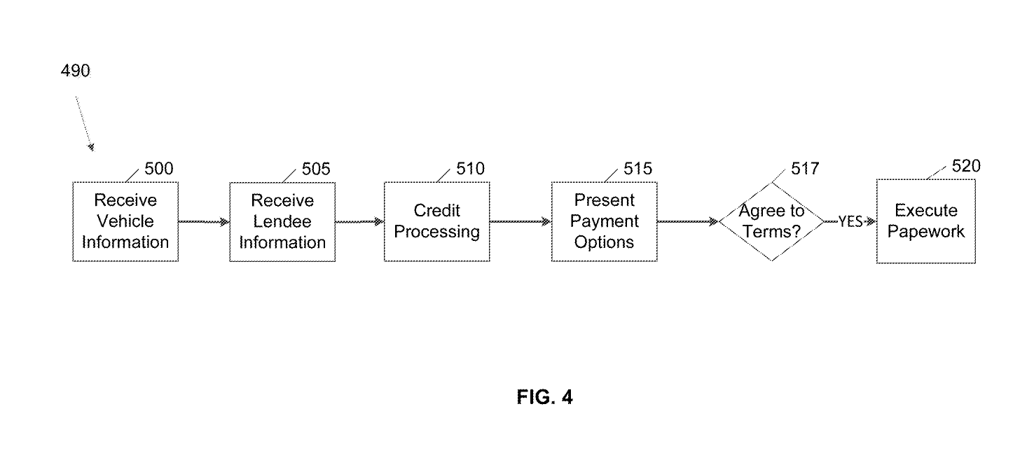

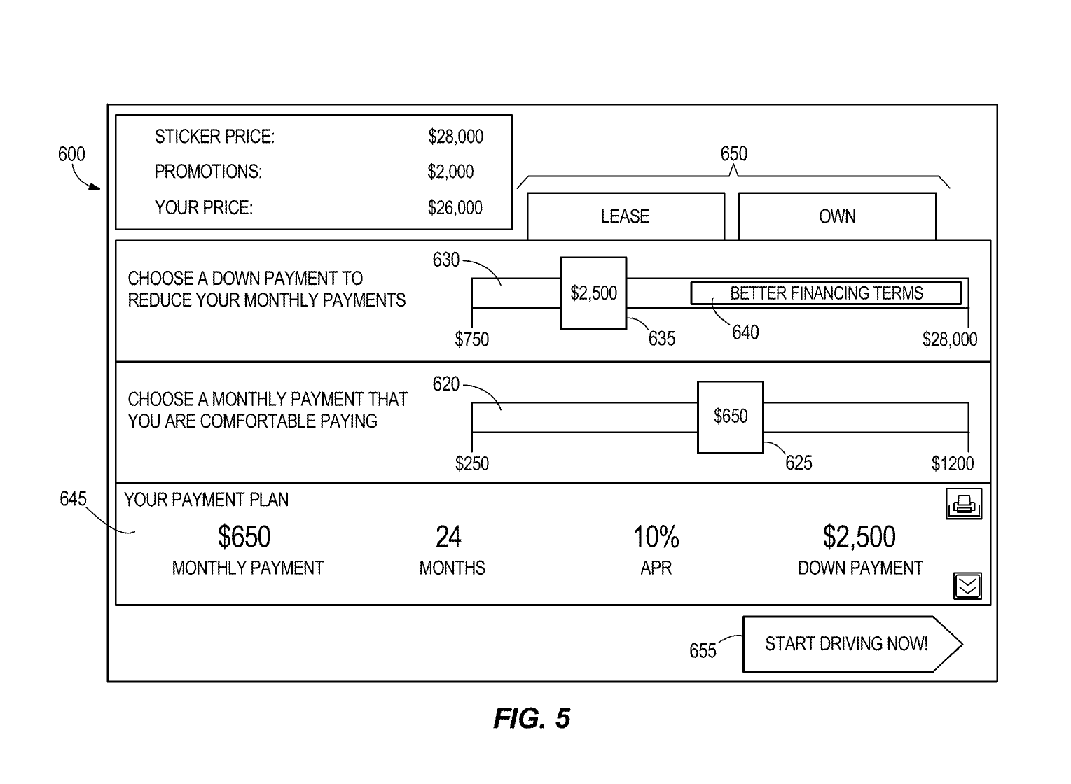

As noted above, embodiments of the invention are not limited to dental or medical applications. In particular, embodiments of the invention can be applicable any type of purchase, including products or services. Also, embodiments of the invention can be applicable to purchases, leases, licenses, and other type of monetary transactions. For example, FIG. 4 illustrates a method 490 for selecting payment terms for leasing or buying a vehicle. The method 490 can be performed using the system 190 described above. As illustrated in FIG. 4, the computing device 200 receives vehicle information (at block 500). The vehicle information can include the full cost of the vehicle (such as a manufacturer's suggested retail price (“MSRP”)), any promotions or discounts applicable to the vehicle, as well as any additional information. The vehicle information can be provided by the lendee (i.e., the individual purchasing the vehicle), the vehicle seller, or another source. The computing device 200 also receives lendee information (at block 505). The lendee information can include financial information or other identifying or personal information. The financial information can include, for example, a credit card number or account number. The computing device 200 system uses the lendee information to run a credit check (at block 510). The results of the credit check can include a credit score and credit history for the lendee. Based on the results of the credit check, the computing device 200 presents payment terms to the lendee (at block 515). In some embodiments, the computing device 200 generates a graphical user interface (“GUI”) that presents the payment terms to the patient. For example, FIG. 5 illustrates a GUI 600 that can be presented to the lendee. The GUI 600 is similar to the GUI 300 described above and includes a first slider 620 that graphically represents a range of monthly payment amounts and a movable first selector 625 for selecting a particular monthly payment amount along the range. The GUI 600 also includes a second slider 630 that graphically represents a range of down payment amounts and a movable second selector 635 for selecting a particular down payment amount along the range. The lendee can use the selectors 625, 635 to select a monthly payment amount and a down payment amount. As illustrated in FIG. 5, one or both of the sliders 620, 630 can have one or more discount ranges 640. The GUI 600 also includes a summary section 645 that displays currently-selected payment terms based on the positions of the selectors 625, 635 on the sliders 620, 630 (e.g., a monthly payment amount, a number of months, an APR, and a down payment amount).

The GUI 600 also includes ownership tabs 650. One of the tabs 650 can be associated with a lease option for the vehicle and the other tab 650 can be associated with a purchase or own option. Depending on which tab the lendee selects, the GUI 600 can present different payment terms or options, different sliders, different ranges for amounts, different discounts, etc.

Returning to FIG. 4, when the lendee agrees to particular payment terms (at block 517), the lendee can select an accept button 655 (e.g., a “Start Driving Now” button) on the GUI 600 to submit the terms to the computing device 200. As described above with respect to the dental procedure embodiment, the computing device 200 generates documentation based on the accepted payment terms. The computing device 200 can also generate forms required for the payment terms. The lendee then executes (e.g., initials and/or signs manually or electronically) the necessary paperwork (at block 520). Also, although no illustrated in FIG. 4, the computing device 200 can allow the lendee to complete the payment term selection process over the course of multiple session and can also allow the lendee to cancel the selection process. Furthermore, the computing device 200 can also collect payment(s) from the lendee.

Thus, embodiments of the present invention relate to systems and methods for providing a lendee with a GUI that allows the lendee to view and select payment options. As noted above, although the present application describes a transaction relating to dental services, the systems and methods disclosed herein can be used for any type of transaction, including payment options for purchasing or leasing services and/or property (e.g., vehicles, property, etc.). Also, it should be understood that the methods and systems disclosed herein can be provided by the service or product provider or by a third-party financing entity (e.g., a bank or financial institution). Furthermore, besides generation and control of the GUI, some or all of the steps of the above process can be performed manually, automatically, or by a combination thereof.

Various features of the invention are set forth in the following claims.

What is claimed is:

1. A system comprising:
a computing device configured to:
receive cost information;
determine, based on the cost information, available payment options;
generate, based on the available payment options, a graphical user interface comprising:
a slider graphically illustrating a range of values for a payment term and a selector movable within the slider for selecting a value within the range of values, wherein the range of values includes a discount range;
receive input from a lendee indicating a desired value from the range of values for the payment term based on a position of the selector along the range of values;
determine if the desired value is within the discount range; and
calculate a payment plan based on the desired value, wherein the payment plan includes a discount when the desired value is within the discount range.

2. The system of claim 1, wherein the computing device is further configured to receive lendee information, wherein the lendee information includes at least one selected from the group comprising personal information, credit information, insurance information, medical history information, and answers to survey questions.

3. The system of claim 2, wherein the answers to the survey questions include payment preferences of the lendee.

4. The system of claim 1, wherein the payment term includes at least one selected from the group comprising a periodic payment amount, a down payment amount, a payment period term, an interest rate, and a discount amount.

5. The system of claim 1, wherein the computing device is further configured to
receive a selection of a preset option from the lendee; and,
display, based on the selection of the preset option, a default position of the selector.

6. The system of claim 5, wherein the default position of the selector represents a most-popular value of the payment term based on historical information.

7. The system of claim 1, wherein the graphical user interface further includes a payment plan summary portion that displays at least one selected from the group comprising the desired value, information related to the discount, and information related to a payment period term, and wherein the computing device is configured to update the payment plan summary portion based on the calculated payment plan.

8. The system of claim 1, wherein the graphical user interface further comprises
a second slider graphically illustrating a second range of values for a second payment term and a second selector movable within the second slider for selecting a value within the second range of values, wherein the second range of values includes a second discount range; and,
wherein the computing device is further configured to
receive input from the lendee indicating a second desired value from the second range of values based on a position of the second selector along the second range of values;
determine if the second desired value is within the second discount range; and
calculate the payment plan based on the second desired value, wherein the payment plan includes a second discount when the second desired value is within the second discount range.

9. The system of claim 1, wherein the discount range is variable.

10. The system of claim 9, wherein the discount range is variable based on a value of a second payment term selected by the lendee.

11. A method for allowing a lendee to select payment terms, the method comprising:
receiving cost information;
determining available payment options based on the cost information;
generating, by a computing device, based on the available payment options, a graphical user interface, the graphical user interface comprising:
a slider graphically illustrating a range of values for a payment term and a selector movable within the slider for selecting a value within the range of values, wherein the range of values includes a discount range;
receiving input, by the computing device, from the lendee indicating a desired value from the range of values for the payment term based on a position of the selector along the range of values;
determining, by the computing device, if the desired value is within the discount range; and
calculating, by the computing device, a payment plan based on the desired value, wherein the payment plan includes a discount when the desired value is within the discount range.

12. The method of claim 11, further comprising receiving lendee information, wherein receiving the lendee information includes receiving at least one selected from the group comprising personal information, credit information, insurance information, medical history information, and answers to survey questions.

13. The method of claim 12, wherein receiving the answers to the survey questions includes receiving a payment preferences of the lendee.

14. The method of claim 11, wherein generating the graphical user interface comprising the slider graphically illustrating a range of values for a payment term includes generating a graphical user interface comprising a slider graphically illustrating a range of values for at least payment term one selected from the group comprising a periodic payment amount, a payment period term, a down payment amount, an interest rate, and a discount amount.

15. The method of claim 11, further comprising:
receiving a selection of a preset option from the lendee; and,
displaying a default position of the selector based on the selection of the preset option.

16. The method of claim 15, wherein receiving the selection of the preset option includes receiving a selection of a most-popular option and wherein displaying the default position includes displaying the selector at a most-popular value of the payment term based on historical information.

17. The system of claim 15, wherein receiving the selection of the preset option includes receiving a selection of at least one selected from the group comprising a lease option and an own option.

18. The method of claim 11, wherein generating the graphical user interface includes generating a graphical user interface comprising a second slider graphically illustrating a second range of values for a second payment term and a second selector movable within the second slider for selecting a value within the second range of values, wherein the second range of values includes a second discount range, and further comprising
receiving from the lendee input indicating a second desired value from the second range of values, based on a position of the second selector along the second range of values;
determining if the second desired value is within the second discount range; and
calculating the payment plan based on the second desired value, wherein the payment plan includes a second discount when the second desired value is within the second discount range.

19. The method of claim 11, further comprising varying the discount range.

20. The method of claim 19, wherein varying the discount range includes varying the discount range based on a value of a second payment term selected by the lendee.
